(19) United States
(12) Patent Application Publication
(10) Pub. No.: US 2013/0209824 A1
(43) Pub. Date: Aug. 15, 2013

(54) TITANIUM ALLOYS

(71) Applicants: Fusheng Sun, Canfield, OH (US); Kuang-O Yu, Highland Heights, OH (US); Ernest M. Crist, JR., Transfer, PA (US)

(72) Inventors: Fusheng Sun, Canfield, OH (US); Kuang-O Yu, Highland Heights, OH (US); Ernest M. Crist, JR., Transfer, PA (US)

(73) Assignee: RTI International Metals, Inc., Niles, OH (US)

(21) Appl. No.: 13/469,300

(22) Filed: May 11, 2012

Related U.S. Application Data
(60) Provisional application No. 61/599,072, filed on Feb. 15, 2012.

(51) Int. Cl. C22C 14/00; B21B 1/00; B32B 15/01

(52) U.S. Cl. 428/544; 420/417; 72/199

(57) ABSTRACT

A titanium alloy contains niobium from 8 to 18% by weight; zirconium from 2 to 15% by weight; tin from 0 to 8% by weight; yttrium from 0.0 to 0.3% by weight, and a balance essentially titanium. The titanium alloy has a low Young's modulus, high yield strength, excellent cold bending properties, and good cold stamping and forming performance.

### CROSS-REFERENCE TO RELATED APPLICATION

This application claims priority from U.S. Provisional Application Ser. No. 61/599,072, filed Feb. 15, 2012, the disclosure of which is incorporated herein by referenced.

### BACKGROUND

1. Field of the Invention

This invention relates generally to titanium base alloys, and more particularly to such alloys having low Young's modulus, high yield strength, and excellent cold bending, stamping and forming properties.

2. Background of the Invention

Commercially developed titanium alloys can provide a wide variety of mechanical properties such as strength, ductility and toughness by controlling alloy composition, volume fraction of constituent phases and microstructures. With high specific strength and corrosion resistance, titanium alloys are used in the fields of aircraft, aerospace, deepwater, automotives, and chemical industry. Titanium alloys are also useful for medical implants and other medical devices due to their excellent corrosion resistance, lower elastic modulus, high strengths, and biocompatibility compared to alternative stainless steel and cobalt-chrome alloys.

Some titanium alloys could be classified into an α type, an α+β type, and a β type, based on their phases and microstructures. The α type titanium alloys (such as Ti-5Al-2.5Sn) have a Young's modulus on the order of 115 GPa, while the α+β type alloys (such as Ti-6Al-4V) have a Young's modulus on the order of 110 GPa, and the β type alloys (such as Ti-15V-3Cr-3Sn-3Al) have a Young's modulus on the order of 80 GPa after solution treatment, and on the order of 105 GPa after aging treatment.

Various attempts have been made at providing lower modulus and high strength titanium alloys for making medical implants and other applications. U.S. Pat. No. 4,952,236 discloses a method of preparing a high strength, low modulus, ductile, biocompatible titanium base alloy (typical composition Ti-11.5Mo-6Zr-2Fe), which is characterized by a modulus of elasticity not exceeding 100 GPa. However, the elastic modulus values of Ti-11.5Mo-6Zr-2Fe alloys are in the range from about 62 to 88 GPa. No cold bending and forming performance data is published.

U.S. Pat. No. 5,169,597 discloses a biocompatible titanium alloy with a low Young's modulus (typical composition Ti-13Zr-13Nb). This alloy is suitable for use as a material for medical prosthetic implants especially where a relatively low modulus of elasticity is important. Again, the elastic modulus values of Ti-13Zr-13Nb alloys are in the range from about 62 to 88 GPa, and again, no cold bending and forming performance data is provided.

U.S. Pat. No. 6,752,882 teaches a biocompatible binary titanium-niobium (Ti—Nb) alloy which has a low modulus and high strength and contains α″ phase as a major phase. The binary Ti—Nb alloy contains 10 to 30 wt % of Nb, preferably 13 to 28 wt % of Nb, and the balance titanium, which is suitable for making an orthopedic implant or dental implant. The elastic modulus values of the Ti—Nb binary alloys are in the range from 61 to 77 GPa. This patent provides no cold bending and forming data.

US Patent Application Publication US2007/0163681 discloses titanium alloys of low Young's modulus (52 to 69 GPa) and high strength (yield strength 990 MPa after cold roll). The titanium alloy contains vanadium, from 10 to 20 wt %, aluminum from 0.2 to 10 wt %, and a balance essentially titanium. The alloy has a microstructure including a martensitic phase. However, no tensile ductility was reported. After cold rolling, this alloy shows very little ductility. In addition, on the cold bending and forming performance, nothing is set forth in the publication.

U.S. Pat. No. 6,607,693 teaches a titanium alloy characterized by an average Young's modulus of 75 GPa or less, and a tensile elastic limit strength of 700 MPa or more. This alloy comprises an element of V group (the vanadium group) in an amount of 30 to 60 wt % and the balance of titanium, and can be used in a variety of fields which require a low Young's modulus and a high elastic deformability. However, no specific cold bending and forming performance data were reported. Although a low “average” Young's modulus is claimed in the invention, the initial tensile Young's modulus is much higher than the “average” modulus that was reported.

A titanium alloy with excellent forming properties (a maximum bend ductility of radius/thickness 2) is disclosed in U.S. Pat. No. 2,864,697. The typical composition of this alloy is Ti-15V-2.5Al (wt %). However, the excellent forming properties can only be obtained at the solution condition in which the strength is very low (yield strength 275 MPa). If the yield strength is increased up to 700 to 800 MPa using aging treatment, the ductility and forming properties are decreased (radius/thickness 5 to 10), but the Young's modulus is also increased.

There remains a significant need for new titanium alloys to improve cold bending, stamping, and forming properties for complicated shape component forming at room temperature (such as applications in electronic sockets and connectors), and to provide low Young's modulus and high yield strength for excellent elastic deformation. Desirably, the titanium alloys should have a Young's modulus about 35 to 45% of that for an α or α+β type titanium alloy, similar yield strengths as that of an α or α+β type titanium alloy, much better room temperature tensile ductility than that of a β type titanium alloy, and excellent bending, stamping and forming properties, as found in advanced copper alloys. Additionally, the titanium alloys should have excellent processing ability that can be readily produced in a variety of forms (foil, wire, sheet and bar). Many of these applications are subject to thermal exposure and corrosion environments.

### BRIEF DESCRIPTION OF THE DRAWINGS

FIG. 1 is a photomicrograph showing the microstructure of one alloy of the present invention (Ti-13Nb-6Zr-4Sn-0.1Y) after beta anneal followed by water quench.

FIG. 2 is a graph showing X-ray diffraction spectra of the alloy of FIG. 1 and thus also after beta anneal followed by water quench.

FIG. 3 is a perspective view showing a schematic die for performing double bend testing.

FIG. 4 is a side elevational view showing six double bend testing samples of 0.040 inch thick sheet as viewed along one side edge of the samples.

FIG. 5 includes two photomicrographs of bend testing samples respectively showing the bent surfaces in the transverse direction and longitudinal direction of 0.008 inch thick pickled and/or ground foils formed from an alloy of the present invention.

FIG. 6 includes a perspective diagrammatic illustration of transverse and longitudinal bends, along with two photomicrographs of bend testing samples showing the bend surfaces respectively in the transverse direction and longitudinal direction of 0.0065 inch thick precision cold rolled foils formed from an alloy of the present invention.

FIG. 7 is a perspective view showing a stamp formed sample of a 0.0065 inch precision cold roll foil of an alloy of the present invention.

### SUMMARY OF THE INVENTION

The present invention provides a titanium alloy containing niobium from 8 to 18% by weight; zirconium from 2 to 15% by weight; tin from 0 to 8% by weight; yttrium from 0.0 to 0.3% by weight, and a balance essentially titanium. The titanium alloy has a low Young's modulus, high yield strength, excellent cold bending properties, and good cold stamping and forming performance.

### DETAILED DESCRIPTION OF THE INVENTION

The alloys of the present invention comprise from 8 to 18% by weight niobium; from 2 to 15% by weight zirconium; from 0.0 to 8% by weight tin; from 0.0 to 0.3% by weight yttrium; and a balance essentially titanium. Although metals of the alloy may fall anywhere within the ranges noted above, the alloy typically comprises from 8, 9, 10, 11, 12 or 13 to 15, 16, 17 or 18% by weight niobium; from 2, 3, 4, 5 or 6 to 8, 9, 10, 11, 12, 13, 14 or 15% by weight zirconium; from 0.5, 1, 2 or 3 to 5, 6, 7 or 8% by weight tin; from 0.0 or 0.05 to 0.2 or 0.3% by weight yttrium; and a balance essentially titanium. Typically, the preferred alloys of the present invention comprise about 13 to 15% by weight niobium, about 6 to 8% by weight zirconium, about 3 to 5% by weight tin, about 0.05 to 0.2% by weight yttrium, and the balance essentially titanium. One particular preferred alloy of the present invention comprises about 13 to 15% by weight niobium, about 6 to 8% by weight zirconium, about 4% by weight tin, about 0.1% by weight yttrium, and the balance essentially titanium. This Ti-(13-15)Nb-(6-8)Zr-4Sn-0.1Y alloy exhibits an excellent combination of desired mechanical properties (low Young's modulus and high yield strength) and excellent cold bending, stamping and forming properties (complex shape part formability).

Typically, the alloys of the present invention consist essentially of the metals or elements noted above. Other elements are usually not deliberately added. The alloys may further contain one or more elements (which have generally been considered unavoidable or incidental impurities) selected from the group consisting of carbon, oxygen and nitrogen, wherein a total amount of one or more of these elements or incidental impurities is no more than 1% by weight and usually no more than 0.5, 0.4, 0.3 or 0.2% by weight. This alloy typically contains no more than 0.5% by weight carbon and usually no more than 0.1, 0.05 or 0.03% by weight carbon. In the exemplary embodiment, this alloy contains about 0.02% by weight carbon. This alloy typically contains no more than 0.5% by weight oxygen and usually no more than 0.4, 0.3 or 0.2% by weight oxygen. In the exemplary embodiment, this alloy contains about 0.10% by weight oxygen. This alloy typically contains no more than 0.5% by weight nitrogen and usually no more than 0.1, 0.05 or 0.03% by weight nitrogen. In the exemplary embodiment, this alloy contains about 0.01% by weight nitrogen. Similarly, the total amount of any element or elements in the alloy other than niobium, zirconium, tin, yttrium and titanium is no more than 1% by weight and usually no more than 0.5, 0.4, 0.3, or 0.2% by weight.

As noted above, the amount of niobium added to the alloy is from 8 to 18% by weight and preferably from 13 to 15% by weight. The niobium content aids greatly in providing a low Young's modulus, as the amount of niobium, an isomorphous beta stabilizer, is sufficient to assist with the formation of alpha prime (α′) martensitic phase (hexagonal structure) after rapid cool from beta phase field via lowering the beta transus temperature and decelerating the precipitation of alpha phase during cooling. The addition of niobium also improves strength.

As also noted above, the alloys of the present invention contain 2 to 15% by weight zirconium and preferably 6 to 8% by weight. Zirconium is mainly added to strengthen the alloy, while it does not decrease the ductility and bending properties. Zirconium was usually believed to be a neutral stabilizer (stabilizing both alpha and beta phase), but the addition of zirconium (typically about 4 to 8% by weight) actually decreases the beta transus temperatures in the alloys of the present invention, thereby assisting with the formation of alpha prime martensitic phase (for low Young's modulus).

The tin in the alloy strengthens the alloy and improves the bending and forming properties. Tin was usually believed to be a neutral stabilizer; however, the addition of tin (typically about 4 to 8% by weight) not only decreases the beta transus temperature, but also enhances the formation of alpha double prime (α″) martensitic phase, an orthorhombic structure which further decreases Young's modulus and increases ductility and bending properties. As the amount of tin above 4% by weight increases up to about 8% by weight, the yield strength of the alloy typically increases and the bending properties of the alloy typically decrease. In the exemplary embodiment, the alloy typically includes no more than 5, 6, 7 or 8% by weight.

The total amount of zirconium and tin, that is, the amount of zirconium and tin together, is preferably within a range of about 6, 7, 8 or 9 to about 11, 12, 13, 14, 15 or 16% by weight. A total amount of zirconium and tin lower than 10% by weight may cause lower yield strength, but improve bending properties. A total amount of zirconium and tin higher than 14% by weight may cause higher yield strength, but lower bending performance. Some of the present alloys with good bending properties have a total amount of zirconium and tin in the range of about 8-11% by weight while this amount for those with the best stamping and forming properties observed was about 10% by weight.

The addition of yttrium to the alloys results in the formation of Y₂O₃ particles, which refine not only the cast microstructure of the ingot, but also refine the re-crystallization microstructure of sheet or foil after beta phase anneal. It increases the bending properties as prior beta grain size is decreased.

The alloys of the present invention may be prepared from commercially pure titanium, zirconium, niobium, tin and yttrium in the appropriate proportions. Master alloys may also be used for decreasing the melting points and obtaining homogeneous chemical composition in the ingot. In practice, the titanium alloy is preferably melted by the plasma arc melting (PAM) process in an atmosphere such as helium, and the alloying elements are added to the melt either as commercially pure components or in the form of pure master alloys as an aim to obtain homogeneous chemical composition. Although the PAM process is a preferred method, the present alloy may, for instance, also be melted by an electron beam (EB) method or vacuum arc remelting (VAR) method.

Generally, the alloys of the present invention should be subjected to thermo-mechanical processing to obtain the desired properties in finished products (foil, wire or sheet). More particularly, after melting and casting, the alloys are typically subjected to thermo-mechanical processing in the usual manner and forged or rolled to the desired wrought semi-finished product. For instance, ingots of the alloys may be forged or bloomed to slab form, and hot rolled to plate, sheet or bar at 1450° F. These hot rolled pieces are typically treated with a solution treatment above the beta transus temperature followed by the rapid cool to room temperature noted below.

To achieve the low Young's modulus and high yield strength in the finished products (foil or sheet) of the present alloys, these alloys are typically subjected to rapid cool from anneal temperatures (above beta transus temperature), followed by cold deformation. The rapid cool from elevated temperatures results in a microstructure containing a mixture of alpha prime (α′) and alpha double prime (α″) phases (martensitic phases) as major phases as illustrated in FIG. 2, thereby making the material with low Young's modulus and high ductility. Subsequent cold deformation (for instance 50 to 70% reduction cold roll) increases its yield strength, further decreases its Young's modulus, and maintains good ductility, bending, stamping and forming performance. Excess cold deformation (for instance 75 to 90% reduction cold roll) may further increase the yield strength but also decrease the bending, stamping and forming performance to an undesirable level. Generally, the cold roll reduction is in the range of 30 to 90% and typically no more than 70 or 75% to achieve the desired properties noted above. This range is usually about 30, 35, 40, 45 or 50% to about 60, 65 or 70%. The cold roll reduction is usually at least 30, 35, 40, 45 or 50% and usually no more than about 65, 70 or 75%.

The titanium alloys of the present invention exhibit high strength, low Young's modulus, excellent or exceptional cold bending and forming performance, providing an expanded range of applications for titanium alloys in various industries such as electronic products (connector and sockets), medical implants, springs and other fields. Preferably, the alloy of the present invention has a yield strength in the range of 650, 675 or 700 to 800, 825, 850, 875 or 900 MPa and a Young's modulus of 40, 41 or 42 to 50, 51 or 52 GPa. An alloy product (foil) formed of one embodiment of the present alloy has a radius/thickness bending ratio (of foil) no greater than about 3.5 or 4.0 in the cold-rolled (foil) condition (thus providing excellent bending properties). Such an alloy product (foil) provides good stamping and forming performance, that is, the ability to cold form with complex shapes in the cold-rolled (foil) condition. More broadly, the above-noted radius/thickness bending ratio (of foil) for alloys of the present invention in the cold rolled condition is typically is no greater than about 7.5, 7.0, 6.5, 6.0, 5.5, 5.0, 4.5, 4.0, 3.5 or 3.0.

The titanium alloy of the present invention thus possesses not only a low Young's modulus (for example, about 35 to 45% of that of an α or α+β type titanium alloy), high yield strength (as good as that of an α or α+β type titanium alloy), and good room temperature tensile ductility (better than that of a β type titanium alloy), but also possesses excellent bending, stamping and forming properties (as good as advanced copper alloys) in both longitudinal and transverse directions of cold rolled material (foil). The latter unique characteristic provides the feasibility to bend and form a complex part.

Table 1 below illustrates the mechanical properties and bending test results of some of the alloys of the present invention and other alloys for comparative purposes, thus emphasizing the advantageous properties of the alloys of the present invention. Among the titanium alloys listed, the alloys of the present invention show the lowest Young's modulus, the best bending properties, and good tensile yield strength. The Young's modulus (E) of the present alloys is only about 33% of that of the advanced copper alloy Cu-3.2Ni-0.7Si while the yield strength of the present alloys is similar to that of Cu-3.2Ni-0.7Si.

TABLE 1
Mechanical and Bending Properties of different alloys (0.040 inch thick sheet)

| | | Bending | Mechanical Properties | | | |
|---|---|---|---|---|---|---|
| Alloy | Composition | Property | E, GPa | YS, MPa | UTS, MPa | El. % |
| A | Cu—3.2Ni—0.7Si | R/t > 1.5 | 130 | 650-750 | 690-860 | 5.0-8.0 |
| B | Ti—6Al—4V | R/t > 4.0 | 110 | 860 | 1000 | 10.0 |
| C | Ti—35.8Nb—2.1Ta—3.1Zr | R/t > 10 | 70 | 915 | 1000 | 1.8 |
| | Ti—35Nb—10Zr | R/t > 10 | 65 | 620 | 700 | 1.1 |
| D | Ti—16.7V—2Al | R/t > 20 | 50 | 920 | 950 | 2.1 |
| | Ti—14.4V—2Al—2Sn | R/t > 20 | 50 | 1010 | 1110 | 3.5 |
| E | Ti—13Zr—13Nb | R/t > 6.5 | 48 | 750 | 960 | 5.0-8.0 |
| Alloys of | Ti—13Nb—4Zr—0.1Y | R/t > 5.5 | 47-50 | 700-750 | 860-960 | 5.0-8.0 |
| present | Ti—(13-15)Nb—(4-10)Zr—(4-8)Sn—0.1Y | R/t > 3.5 | 44-48 | 700-750 | 860-960 | 5.0-8.0 |
| invention | | | | | | |

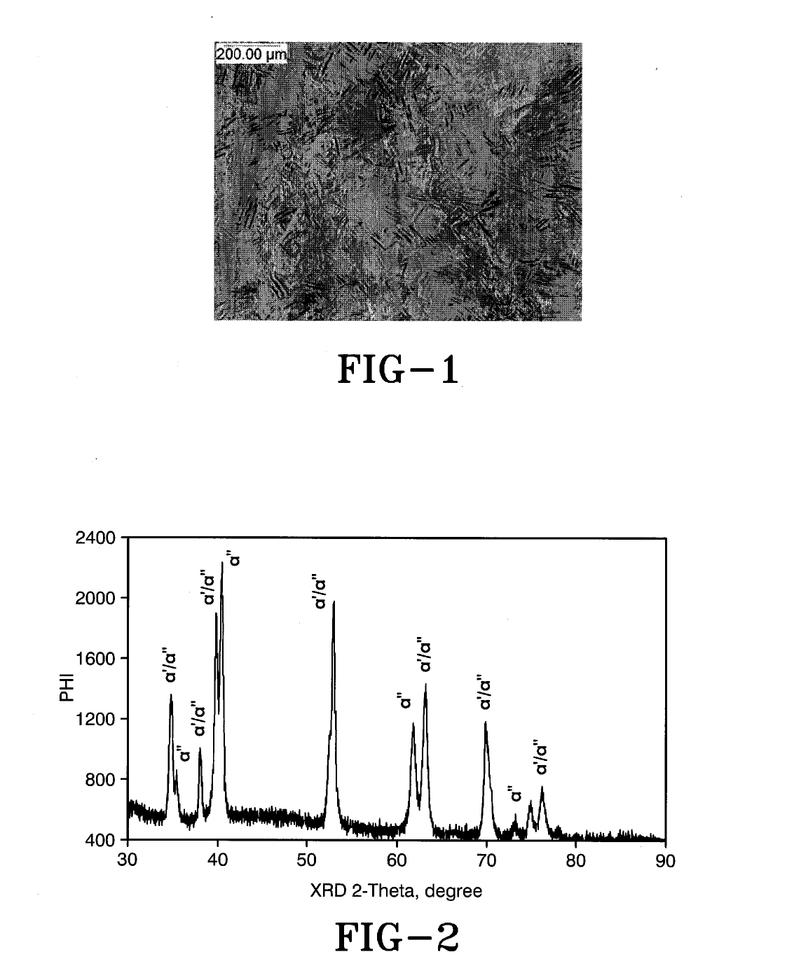

A batch of ten alloys (Alloys 1 to 10 in the tables below) was produced and processed. The composition of each alloy of the present invention is shown in Table 2, while Table 3 shows their beta transus temperatures. In particular, the alloys were melted into about 12-pound slab buttons (1.1×4.2×10 inch) using a plasma arc melting (PAM) furnace. Each slab button was re-melted 4 to 6 times to ensure its chemical uniformity. The slab buttons were homogenized at 1850° F. for two hours, hot rolled down to 0.45 inch thick plates at 1600° F., and subsequently hot rolled down to sheets having a thickness of 0.08 to 0.23 inch. The sheets were annealed at 1425 to 1550° F. for one hour followed by water quench, and surface conditioning. The as-water-quench microstructure is a mixture of alpha prime and alpha double prime martensitic phases as shown in FIGS. 1 and 2. The sheets with a thickness from 0.080 to 0.120 inch thick were cold rolled down to 0.040 inch sheets with a cold reduction of 50, 60, 65, 70, 75, and 80%, respectively.

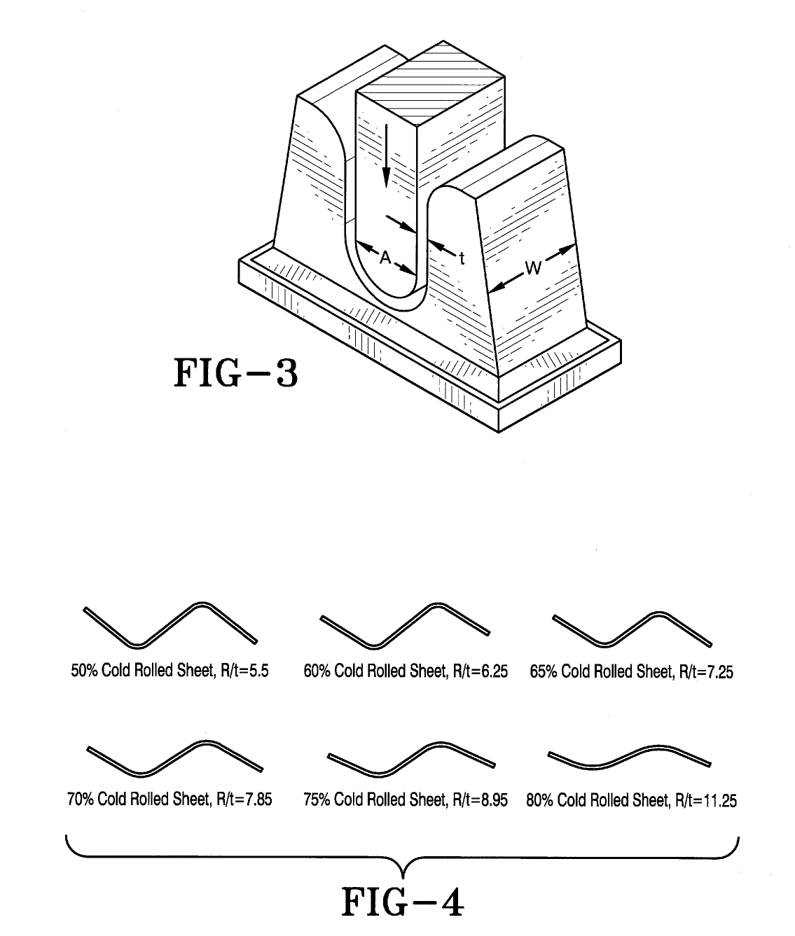

These cold rolled sheets were tested regarding their mechanical properties and double bending properties. The schematic die for double bend testing is shown in FIG. 3 and the double bend testing samples of Alloy No. 6 are shown in FIG. 4. Mechanical properties are shown in Table 4, and double bending testing results are shown in Table 5. Table 4 indicates that the alloys containing 4.0 wt % tin show lower Young's modulus than the alloys with 6.0 to 8.0 wt % tin. The alloy Ti-15Nb-6Zr-4Sn-0.1Y shows the lowest Young's modulus of those in Table 4. The yield and ultimate tensile strengths vary with the compositions. In general, the strengths are increased with increasing the total amount of zirconium and tin in the alloy.

As shown in Table 5, the double bend testing properties depend not only on the compositions but also on the cold rolled conditions of the sheets. The minimum radius/thickness ratio generally increases with increasing the amount of cold-roll-deformation of the sheets. Alloys 1-4 have smaller radius/thickness ratios, which are less dependent on the cold roll deformation than that of Alloys 5-10. Alloys 1-4 provide better bending properties and wider processing window, since the finished products (foil, wire and sheet) require cold deformation to achieve the desired mechanical properties.

TABLE 2
Chemical Compositions of the Titanium Alloys (wt %)

| Alloy No. | Nb | Zr | Sn | Y | O | C | N | Ti |
|---|---|---|---|---|---|---|---|---|
| 1 | 13.0 | 4.0 | 0.0 | 0.1 | 0.10 | 0.02 | 0.01 | Bal |
| 2 | 13.0 | 4.0 | 4.0 | 0.1 | 0.10 | 0.02 | 0.01 | Bal |
| 3 | 13.0 | 6.0 | 4.0 | 0.1 | 0.10 | 0.02 | 0.01 | Bal |
| 4 | 15.0 | 6.0 | 4.0 | 0.1 | 0.10 | 0.02 | 0.01 | Bal |
| 5 | 13.0 | 10.0 | 4.0 | 0.1 | 0.10 | 0.02 | 0.01 | Bal |
| 6 | 13.0 | 13.0 | 0.0 | 0.1 | 0.10 | 0.02 | 0.01 | Bal |
| 7 | 13.0 | 8.0 | 6.0 | 0.1 | 0.10 | 0.02 | 0.01 | Bal |
| 8 | 13.0 | 6.0 | 8.0 | 0.1 | 0.10 | 0.02 | 0.01 | Bal |
| 9 | 13.0 | 8.0 | 8.0 | 0.1 | 0.10 | 0.02 | 0.01 | Bal |
| 10 | 13.0 | 4.0 | 8.0 | 0.1 | 0.10 | 0.02 | 0.01 | Bal |

TABLE 3
Beta Transus Temperature of the Titanium Alloys

| | | Beta Transus |
|---|---|---|
| Alloy No. | Composition, wt % | Temperature, degree F. |
| 1 | Ti—13Nb—4Zr—0.1Y | 1460.4 |
| 2 | Ti—13Nb—4Zr—4Sn—0.1Y | 1428.3 |
| 3 | Ti—13Nb—6Zr—4Sn—0.1Y | 1400.1 |
| 4 | Ti—15Nb—6Zr—4Sn—0.1Y | 1350.9 |
| 5 | Ti—13Nb—10Zr—4Sn—0.1Y | 1361.6 |
| 6 | Ti—13Nb—13Zr—0.1Y | 1375.8 |
| 7 | Ti—13Nb—8Zr—6Sn—0.1Y | 1360.9 |
| 8 | Ti—13Nb—6Zr—8Sn—0.1Y | 1383.2 |
| 9 | Ti—13Nb—8Zr—8Sn—0.1Y | 1356.4 |
| 10 | Ti—13Nb—4Zr—8Sn—0.1Y | 1403.4 |

TABLE 4
Mechanical Properties of Cold Rolled (70%) Sheets (0.040″ thick)

| | | Mechanical Properties | | | |
|---|---|---|---|---|---|
| Alloy | | | YS, | UTS, | |
| No. | Composition, wt % | E, GPa | MPa | MPa | El., % |
| 1 | Ti—13Nb—4Zr—0.1Y | 47.9 | 714.7 | 809.8 | 6.00 |
| 2 | Ti—13Nb—4Zr—4Sn—0.1Y | 47.4 | 743.2 | 855.9 | 6.70 |
| 3 | Ti—13Nb—6Zr—4Sn—0.1Y | 47.7 | 722.1 | 872.1 | 5.10 |
| 4 | Ti—15Nb—6Zr—4Sn—0.1Y | 44.1 | 709.4 | 855.4 | 6.40 |
| 5 | Ti—13Nb—10Zr—4Sn—0.1Y | 47.4 | 803.7 | 934.3 | 4.80 |
| 6 | Ti—13Nb—13Zr—0.1Y | 50.5 | 776.2 | 946.0 | 5.80 |
| 7 | Ti—13Nb—8Zr—6Sn—0.1Y | 48.4 | 807.2 | 956.4 | 5.20 |
| 8 | Ti—13Nb—6Zr—8Sn—0.1Y | 48.6 | 824.9 | 984.8 | 4.90 |
| 9 | Ti—13Nb—8Zr—8Sn—0.1Y | 48.2 | 787.5 | 952.5 | 5.20 |
| 10 | Ti—13Nb—4Zr—8Sn—0.1Y | 49.3 | 770.4 | 909.5 | 6.10 |

TABLE 5
Double Bend Testing Results of Cold Rolled Sheets (0.040″ thick)

| | | Cold Roll Reduction (top row) | | | | | |
|---|---|---|---|---|---|---|---|
| | | Bend Testing Minimum R/t (transverse) | | | | | |
| Alloy No. | Composition, wt % | 50% | 60% | 65% | 70% | 75% | 80% |
| 1 | Ti—13Nb—4Zr—0.1Y | 3.58 | 3.23 | 4.05 | 3.50 | 4.00 | 6.02 |
| 2 | Ti—13Nb—4Zr—4Sn—0.1Y | 3.88 | 3.54 | 4.85 | 5.19 | 4.92 | 6.41 |
| 3 | Ti—13Nb—6Zr—4Sn—0.1Y | 4.25 | 4.59 | — | 5.50 | — | 6.25 |
| 4 | Ti—15Nb—6Zr—4Sn—0.1Y | 4.21 | 5.64 | — | 7.07 | — | 7.15 |
| 5 | Ti—13Nb—10Zr—4Sn—0.1Y | 5.50 | 6.25 | — | 8.25 | — | 10.15 |
| 6 | Ti—13Nb—13Zr—0.1Y | 5.50 | 6.25 | 7.25 | 7.85 | 8.95 | 11.25 |
| 7 | Ti—13Nb—8Zr—6Sn—0.1Y | 6.25 | 9.38 | — | 12.10 | — | 12.50 |
| 8 | Ti—13Nb—6Zr—8Sn—0.1Y | 7.25 | 10.0 | — | 10.10 | — | 10.71 |
| 9 | Ti—13Nb—8Zr—8Sn—0.1Y | 8.25 | 8.93 | — | 11.63 | — | 14.20 |
| 10 | Ti—13Nb—4Zr—8Sn—0.1Y | 7.25 | 7.55 | — | 10.00 | — | 9.38 |

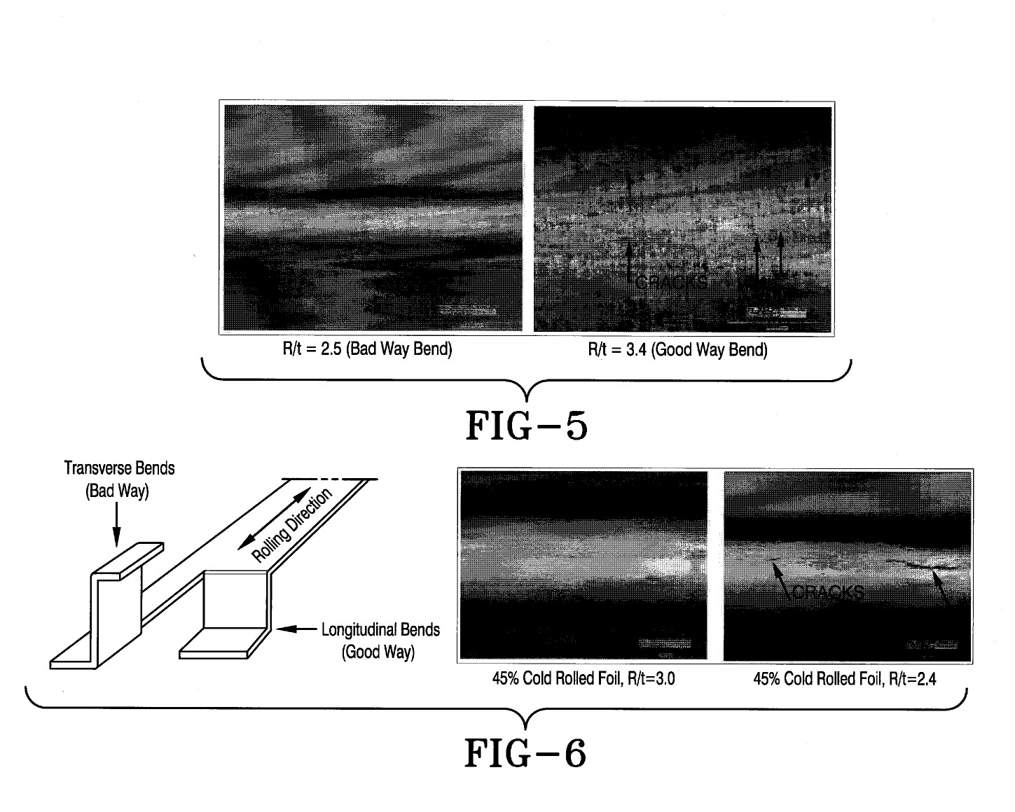

Some of the cold rolled sheets discussed above were subjected to annealing, and subsequently additional cold pack rolling down to 0.015 inch thick foils, and then pickled and/or ground to foils with a thickness of 0.008 inch. Bend testing was performed on these pickled and/or ground foils both in the longitudinal direction (good way bends) and transverse direction (bad way bends), the results of which are shown below in Table 6. Two bend samples are shown in FIG. 5. Unexpectedly, the bend testing shows smaller minimum radius/thickness ratio in the longitudinal direction than in the transverse direction. The minimum radius/thickness ratio in the longitudinal direction may be as small as 2.50 or lower, as illustrated by the results shown in FIG. 5. This may be attributed to foil textures of cold-deformed alpha prime and alpha double prime martensitic phases. However, the detailed causes are still unclear. The results are completely different from the conventional titanium alloys. The unique bending properties of the alloys of the present invention can be used for bending and forming complex shape parts.

TABLE 6
Bend Testing of Pack-Rolled & Pickled Foils (0.008″ Thick)

| Cold Roll Reduction | | | | |
|---|---|---|---|---|
| Alloy | | Bend Testing Minimum R/t | | |
| No. | Composition, wt % | Transverse | Longitudinal | Total reduction |
| 1 | Ti—13Nb—4Zr—0.1Y | 4.00 | 3.06 | 55% rolled, pickled |
| 2 | Ti—13Nb—4Zr—4Sn—0.1Y | 4.00 | 2.67 | 45% rolled, pickled & |
| | | | | grind |
| 3 | Ti—13Nb—6Zr—4Sn—0.1Y | — | — | Not available |
| 4 | Ti—15Nb—6Zr—4Sn—0.1Y | — | — | Not available |
| 5 | Ti—13Nb—10Zr—4Sn—0.1Y | 4.00 | 3.20 | 55% rolled, pickled |
| 6 | Ti—13Nb—13Zr—0.1Y | 4.00 | 2.53 | 45% rolled, pickled & |
| | | | | grind |
| 7 | Ti—13Nb—8Zr—6Sn—0.1Y | 4.00 | 3.71 | 55% rolled, pickled |
| 8 | Ti—13Nb—6Zr—8Sn—0.1Y | 5.05 | 3.78 | 55% rolled, pickled |
| 9 | Ti—13Nb—8Zr—8Sn—0.1Y | 6.00 | 5.07 | 65% rolled, pickled |
| 10 | Ti—13Nb—4Zr—8Sn—0.1Y | 5.00 | 3.14 | 55% rolled, pickled |

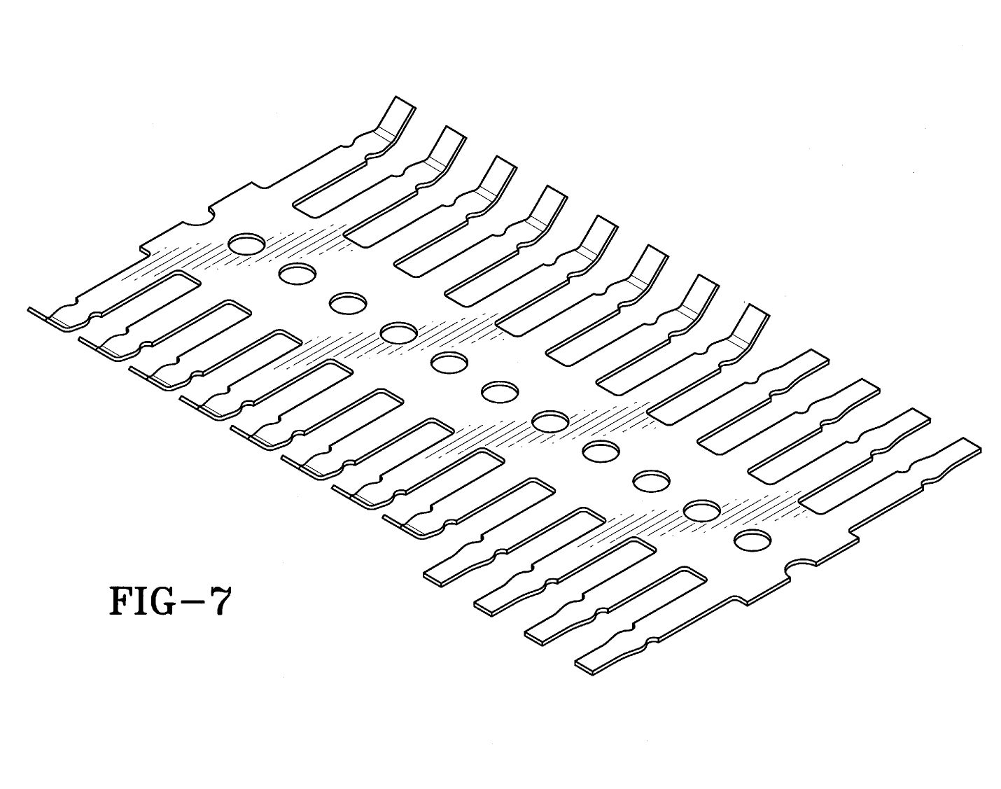

Ten pieces of foil with a size of 0.0065 inch thick by 3 inch wide and by 20 inch long were formed from the alloys of the present invention using a precision cold roll mill. Bend testing was carried out in both the longitudinal direction and transverse direction, as shown in Table 7 and FIG. 6. Stamping and forming trials were performed as shown in Table 8 and FIG. 7. These bend testing results confirm the above-noted unexpected results that the minimum radius/thickness ratio in the longitudinal direction is smaller than (or equal to) that in the transverse direction. Alloys 1-4 show smaller radius/thickness ratio than that of Alloys 5-10, consistent with previous bending testing results on the pickled foils. Alloy 4 shows the best bending properties in both orientations. Stamping and forming performance is dependent on the bending properties. Alloys 3-4 show the best stamping and forming properties. No orange peel or cracks were observed for the cold stamped and formed parts of Alloys 3 and 4.

TABLE 7
Bend Testing of Precision Cold Rolled Foils (0.0065″ thick)

| | |
|---|---|
| Cold Roll Reduction | Bend Testing Minimum R/t |

| Alloy | | Transverse | Longitudinal |
|---|---|---|---|
| No. | Composition, wt % | direction | direction |
| 1 | Ti—13Nb—4Zr—0.1Y | 4.00 | 3.43 |
| 2 | Ti—13Nb—4Zr—4Sn—0.1Y | 4.57 | 3.43 |
| 3 | Ti—13Nb—6Zr—4Sn—0.1Y | 4.00 | 3.43 |
| 4 | Ti—15Nb—6Zr—4Sn—0.1Y | 3.43 | 3.43 |
| 5 | Ti—13Nb—10Zr—4Sn—0.1Y | 4.49 | 4.00 |
| 6 | Ti—13Nb—13Zr—0.1Y | 4.86 | 4.00 |
| 7 | Ti—13Nb—8Zr—6Sn—0.1Y | 4.46 | 4.46 |
| 8 | Ti—13Nb—6Zr—8Sn—0.1Y | 5.43 | 4.57 |
| 9 | Ti—13Nb—8Zr—8Sn—0.1Y | 5.43 | 5.43 |
| 10 | Ti—13Nb—4Zr—8Sn—0.1Y | 5.43 | 4.46 |

TABLE 8
Stamping and Forming Results of the 0.0065 inch thick precision cold
roll foils

| Alloy No. | Composition, wt % | Evaluations |
|---|---|---|
| 1 | Ti—13Nb—4Zr—0.1Y | Orange peel |
| 2 | Ti—13Nb—4Zr—4Sn—0.1Y | Relatively smooth surface, |
| | | a very tiny crack |
| 3 | Ti—13Nb—6Zr—4Sn—0.1Y | Relative smooth surface |
| 4 | Ti—15Nb—6Zr—4Sn—0.1Y | Relative smooth surface |
| 5 | Ti—13Nb—10Zr—4Sn—0.1Y | Cracks |
| 6 | Ti—13Nb—13Zr—0.1Y | Relatively smooth surface, |
| | | a very tiny crack |
| 7 | Ti—13Nb—8Zr—6Sn—0.1Y | Cracks |
| 8 | Ti—13Nb—6Zr—8Sn—0.1Y | Cracks |
| 9 | Ti—13Nb—8Zr—8Sn—0.1Y | Cracks |
| 10 | Ti—13Nb—4Zr—8Sn—0.1Y | Orange peel |

Several examples of the alloys of the present invention are provided below. These examples are not intended to limit the scope of the invention in any way.

### Example 1

A titanium alloy containing by weight 13% niobium, 4% zirconium, 4% tin, and 0.1% yttrium (Alloy No. 2), was melted and hot rolled at 1600° F., and subsequently at 1350° F. to sheets with a thickness of 0.080 to 0.200 inch. The sheets were annealed at 1550° F. for 1 hour, followed by water quench to room temperature. The beta transus temperature for this alloy was about 1428° F. These sheets were subsequently cold rolled to 0.040 inch thick with a reduction of 50, 60, 70, and 80%, respectively. The mechanical properties and double bend testing results of the as-cold rolled conditions are shown in Table 9. This alloy shows good bending properties.

TABLE 9
Properties of Ti—13Nb—4Zr—4Sn—0.1Y
(Alloy No. 2, 0.040 inch thick sheet)

| | Sample ID | | | |
|---|---|---|---|---|
| | #732 | #731 | #721 | #711 |
| Cold Roll Reduction, % | 50% | 60% | 70% | 80% |
| Modulus E, GPa | 48.5 | 47.6 | 47.4 | 46.7 |
| Yield Strength, MPa | 733 | 728 | 743 | 767 |
| Ultimate Tensile Strength, MPa | 835 | 835 | 856 | 886 |
| Elongation, % | 6.0 | 6.8 | 6.7 | 6.8 |
| Bending properties, minimum | 3.88 | 3.54 | 5.19 | 6.41 |
| radius/thickness | | | | |

| | |
|---|---|
| Note | Three tensile samples average |

### Example 2

Compared to Example 1, Example 2 shows a higher tin containing titanium alloy with, by weight, 13% niobium, 4% zirconium, 8% tin, and 0.1% yttrium (Alloy No. 10), was melted and hot rolled at 1600° F., and subsequently at 1475° F. to sheets with a thickness from 0.080 to 0.200 inch. The sheets were annealed at 1475° F. for 1 hour, followed by water quench to room temperature. The beta transus temperature for this alloy was about 1403° F. Those sheets were subsequently cold rolled to 0.040 inch thick with a reduction of 50, 60, 70, and 80%, respectively. The mechanical properties and double bend testing results of the as-cold rolled conditions are shown in Table 10. The bending properties of this alloy were decreased by further addition of tin up to 8%.

TABLE 10
Properties of Ti—13Nb—4Zr—8Sn—0.1Y
(Alloy No. 10, 0.040 inch thick sheet)

| | Sample ID | | | |
|---|---|---|---|---|
| | #332 | #331 | #321 | #311 |
| Cold Roll Reduction, % | 50% | 60% | 70% | 80% |
| Modulus E, GPa | 48.2 | 49.8 | 49.3 | 49.5 |
| Yield Strength, MPa | 732 | 742 | 770 | 765 |
| Ultimate Tensile Strength, MPa | 871 | 898 | 909 | 913 |
| Elongation, % | 4.2 | 6.0 | 6.1 | 4.7 |
| Bending properties, minimum | 7.25 | 7.55 | 10.00 | 9.38 |
| radius/thickness | | | | |

| | |
|---|---|
| Note | Three tensile samples average |

### Example 3

Example 3 is a titanium alloy containing by weight 13% niobium, 6% zirconium, 4% tin, and 0.1% yttrium (Alloy No. 3). This alloy was melted and hot rolled at 1600° F., and subsequently at 1350 to 1450° F. to sheets with a thickness from 0.080 to 0.200 inch. The sheets were annealed at 1425° F. for 1 hour, followed by water quench to room temperature. The beta transus temperature for this alloy was about 1400° F. These sheets were subsequently cold rolled to 0.040 inch thick with a reduction of 50, 60, 70, and 80%, respectively. The mechanical properties and double bend testing results of the as-cold rolled conditions are shown in Table 11. This alloy shows low Young's modulus and good bending properties.

TABLE 11
Properties of Ti—13Nb—6Zr—4Sn—0.1Y
(Alloy No. 3, 0.040 inch thick sheet)

| | Sample ID | | | |
|---|---|---|---|---|
| | #132 | #131 | #121 | #111 |
| Cold Roll Reduction, % | 50% | 60% | 70% | 80% |
| Modulus E, GPa | 47.8 | 47.4 | 47.7 | 47.7 |
| Yield Strength, MPa | 698 | 712 | 722 | 753 |
| Ultimate Tensile Strength, MPa | 831 | 855 | 872 | 897 |
| Elongation, % | 5.0 | 5.7 | 5.1 | 4.3 |
| Bending properties, minimum | 4.25 | 4.59 | 5.50 | 6.25 |
| radius/thickness | | | | |

| | |
|---|---|
| Note | Three tensile samples average |

### Example 4

Compared to Example 3, Example 4 is a higher niobium containing titanium alloy with, by weight, 15% niobium, 6% zirconium, 4% tin, and 0.1% yttrium (Alloy No. 4), and was melted and hot rolled at 1600° F., and subsequently at 1350 to 1450° F. to sheets with a thickness from 0.080 to 0.200 inch. The sheets were annealed at 1425° F. for 1 hour, followed by water quench to room temperature. The beta transus temperature for this alloy was about 1351° F. These sheets were subsequently cold rolled to 0.040 inch thick with a reduction of 50, 60, 70, and 80%, respectively. The mechanical properties and double bend testing results of the as-cold rolled conditions are shown in Table 12. This alloy shows the lowest Young's modulus and good bending properties.

TABLE 12
Properties of Ti—15Nb—6Zr—4Sn—0.1Y
(Alloy No. 4, 0.040 inch thick sheet)

| | Sample ID | | | |
|---|---|---|---|---|
| | #232 | #231 | #221 | #211 |
| Cold Roll Reduction, % | 50% | 60% | 70% | 80% |
| Modulus E, GPa | 42.4 | 44.1 | 44.1 | 44.9 |
| Yield Strength, MPa | 689 | 698 | 709 | 718 |
| Ultimate Tensile Strength, MPa | 819 | 845 | 855 | 871 |
| Elongation, % | 6.2 | 6.4 | 6.4 | 6.2 |
| Bending properties, minimum | 4.21 | 5.64 | 7.07 | 7.15 |
| radius/thickness | | | | |

| | |
|---|---|
| Note | Three tensile samples average |

### Example 5

Example 5 is a titanium alloy containing by weight 13% niobium, 8% zirconium, 6% tin, and 0.1% yttrium (Alloy No. 7), and was melted and hot rolled at 1600° F., and subsequently at 1475° F. to sheets with a thickness from 0.080 to 0.200 inch. The sheets were annealed at 1475° F. for 1 hour, followed by water quench to room temperature. The beta transus temperature for this alloy was about 1361° F. Those sheets were subsequently cold rolled to 0.040 inch thick with a reduction of 50, 60, 70, and 80%, respectively. The mechanical properties and double bend testing results of the as-cold rolled conditions are shown in Table 13. Increasing the total amount of zirconium and tin (total 14%) in this alloy increases the yield and ultimate tensile strengths, but decreases the bending properties.

TABLE 13
Properties of Ti—13Nb—8Zr—6Sn—0.1Y
(Alloy No. 7, 0.040 inch thick sheet)

| | Sample ID | | | |
|---|---|---|---|---|
| | #2832 | #2831 | #2821 | #2811 |
| Cold Roll Reduction, % | 50% | 60% | 70% | 80% |
| Modulus E, GPa | 49.9 | 49.1 | 48.4 | 48.6 |
| Yield Strength, MPa | 783 | 787 | 807 | 828 |
| Ultimate Tensile Strength, MPa | 911 | 937 | 986 | 970 |
| Elongation, % | 4.4 | 5.7 | 5.2 | 4.7 |
| Bending properties, minimum | 6.25 | 9.38 | 12.10 | 12.50 |
| radius/thickness | | | | |

| | |
|---|---|
| Note | Three tensile samples average |

### Example 6

Example 6 shows a higher tin containing titanium alloy with, by weight, 13% niobium, 6% zirconium, 8% tin, and 0.1% yttrium (Alloy No. 8). This alloy was melted and hot rolled at 1600° F., and subsequently at 1475° F. to sheets with a thickness from 0.080 to 0.200 inch. The sheets were annealed at 1475° F. for 1 hour, followed by water quench to room temperature. The beta transus temperature for this alloy was about 1383° F. These sheets were subsequently cold rolled to 0.040 inch thick with a reduction of 50, 60, 70, and 80%, respectively. The mechanical properties and double bend testing results of the as-cold rolled conditions are shown in Table 14. This alloy with the higher amount of tin and high total amount of zirconium and tin (total 14%) shows high strengths, but lower bending properties.

TABLE 14
Properties of Ti—13Nb—6Zr—8Sn—0.1Y
(Alloy No. 8, 0.040 inch thick sheet)

| | Sample ID | | | |
|---|---|---|---|---|
| | #1732 | #1731 | #1721 | #1711 |
| Cold Roll Reduction, % | 50% | 60% | 70% | 80% |
| Modulus E, GPa | 47.1 | 47.9 | 48.2 | 47.8 |
| Yield Strength, MPa | 781 | 789 | 788 | 825 |
| Ultimate Tensile Strength, MPa | 920 | 951 | 953 | 921 |
| Elongation, % | 5.1 | 4.7 | 5.2 | 2.2 |
| Bending properties, minimum | 7.25 | 10.0 | 10.10 | 10.71 |
| radius/thickness | | | | |

| | |
|---|---|
| Note | Three tensile samples average |

### Example 7

Example 7 provides a higher zirconium and tin containing titanium alloy with, by weight, 13% niobium, 8% zirconium, 8% tin, and 0.1% yttrium (Alloy No. 9). This alloy was melted and hot rolled at 1600° F., and subsequently at 1475° F. to sheets with a thickness from 0.080 to 0.200 inch. The sheets were annealed at 1525° F. for 1 hour, followed by water quench to room temperature. The beta transus temperature for this alloy was about 1356° F. Those sheets were subsequently cold rolled to 0.040 inch thick with a reduction of 50, 60, 70, and 80%, respectively. The mechanical properties and double bend testing results of the as-cold rolled conditions are shown in Table 15. This alloy with the highest total amount of zirconium and tin (total 16%) shows the highest yield and ultimate tensile strengths, but lower bending properties.

TABLE 15
Properties of Ti—13Nb—8Zr—8Sn—0.1Y
(Alloy No. 9, 0.040 inch thick sheet)

| | Sample ID | | | |
|---|---|---|---|---|
| | #1832 | #1831 | #1821 | #1811 |
| Cold Roll Reduction, % | 50% | 60% | 70% | 80% |
| Modulus E, GPa | 47.6 | 48.7 | 48.6 | 47.8 |
| Yield Strength, MPa | 808 | 812 | 825 | 847 |
| Ultimate Tensile Strength, MPa | 950 | 971 | 985 | 1002 |
| Elongation, % | 4.6 | 4.7 | 4.9 | 4.1 |
| Bending properties, minimum | 8.25 | 8.93 | 11.63 | 14.20 |
| radius/thickness | | | | |

| | |
|---|---|
| Note | Three tensile samples average |

### Example 8

Example 8 is a higher zirconium containing titanium alloy with, by weight, 13% niobium, 10% zirconium, 4% tin, and 0.1% yttrium (Alloy No. 5), and was melted and hot rolled at 1600° F., and subsequently at 1475° F. to sheets with a thickness from 0.080 to 0.200 inch. The sheets were annealed at 1475° F. for 1 hour, followed by water quench to room temperature. The beta transus temperature for this alloy was about 1361° F. Those sheets were subsequently cold rolled to 0.040 inch thick with a reduction of 50, 60, 70, and 80%, respectively. The mechanical properties and double bend testing results of the as-cold rolled conditions are shown in Table 16. This alloy with high total amount of zirconium and tin (total 14%) shows higher yield and ultimate tensile strengths, and good bending properties.

TABLE 16
Properties of Ti—13Nb—10Zr—4Sn—0.1Y
(Alloy No. 5, 0.040 inch thick sheet)

| | Sample ID | | | |
|---|---|---|---|---|
| | #2932 | #2931 | #2921 | #2911 |
| Cold Roll Reduction, % | 50% | 60% | 70% | 80% |
| Modulus E, GPa | 45.9 | 47.1 | 47.4 | 47.8 |
| Yield Strength, Mpa | 776 | 788 | 804 | 862 |
| Ultimate Tensile Strength, Mpa | 881 | 917 | 934 | 982 |
| Elongation, % | 3.4 | 5.1 | 3.7 | 2.7 |
| Bending properties, minimum | 5.50 | 6.25 | 8.25 | 10.15 |
| radius/thickness | | | | |

| | |
|---|---|
| Note | Three tensile samples average |

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A titanium alloy comprising:
niobium from 8 to 18% by weight;
zirconium from 2 to 15% by weight;
tin from 0.5 to 8% by weight;
yttrium from 0.0 to 0.3% by weight; and
a balance essentially titanium.

2. The titanium alloy of claim 1 wherein the alloy comprises niobium from 11 to 17% by weight; zirconium from 4 to 10% by weight; and tin from 2 to 7% by weight.

3. The titanium alloy of claim 2 wherein the alloy comprises niobium from 13 to 15% by weight; zirconium from 6 to 8% by weight; and tin from 3 to 5% by weight.

4. The titanium alloy of claim 2 wherein the alloy comprises yttrium from 0.05 to 0.3% by weight.

5. The titanium alloy of claim 1 wherein the alloy comprises niobium from 11 to 17% by weight.

6. The titanium alloy of claim 1 wherein the alloy comprises zirconium from 4 to 12% by weight.

7. The titanium alloy of claim 1 wherein the alloy comprises tin from 2 to 8% by weight.

8. The titanium alloy of claim 7 wherein the alloy comprises tin from 3 to 6% by weight.

9. The titanium alloy of claim 1 wherein the alloy comprises yttrium from 0.05 to 0.3% by weight.

10. The titanium alloy of claim 1 wherein the zirconium and tin together make up by weight 6 to 16% of the alloy.

11. The titanium alloy of claim 10 wherein the zirconium and tin together make up by weight 6 to 12% of the alloy.

12. The titanium alloy of claim 1 wherein the alloy has a Young's modulus of no more than 52 GPa.

13. The titanium alloy of claim 12 wherein the alloy has a yield strength of at least 650 MPa.

14. The titanium alloy of claim 13 wherein the alloy in the form of a 0.040-inch thick sheet has a bend testing minimum radius to thickness ratio no greater than 7.5.

15. The titanium alloy of claim 1 wherein the alloy has a yield strength of at least 650 MPa.

16. The titanium alloy of claim 1 wherein the alloy in the form of a 0.040-inch thick sheet has a bend testing minimum radius to thickness ratio no greater than 7.5.

17. The titanium alloy of claim 1 wherein the alloy in the form of a 0.008-inch thick foil has a bend testing minimum radius to thickness ratio no greater than 7.5.

18. The titanium alloy of claim 1 wherein the alloy in the form of a 0.0065-inch thick foil has a bend testing minimum radius to thickness ratio no greater than 7.5.

19. A titanium alloy comprising:
niobium from 8 to 18% by weight;
zirconium from 2 to 15% by weight;
yttrium from 0.05 to 0.3% by weight; and
a balance essentially titanium.

20. A method comprising the step of:
providing a titanium alloy comprising by weight niobium from 8 to 18%, zirconium from 2 to 15%, tin from 0.5 to 8%, yttrium from 0.0 to 0.3%, and a balance essentially titanium; and
cold rolling the alloy at a reduction of 30 to 90% to form a titanium alloy product which has Young's modulus of no more than 52, a yield strength of at least 650 Mpa, and a bend testing minimum radius to thickness ratio no greater than 7.5.
